(19) United States
(12) Patent Application Publication
(10) Pub. No.: US 2024/0009565 A1
(43) Pub. Date: Jan. 11, 2024

(54) PROGRAM, ELECTRONIC DEVICE, AND METHOD FOR GAME

(71) Applicant: CYGAMES, INC., Tokyo (JP)

(72) Inventors: Eiji Nakanishi, Tokyo (JP); Satoshi Nakajima, Tokyo (JP); Keisuke Kumagai, Tokyo (JP)

(73) Assignee: CYGAMES, INC., Tokyo (JP)

(21) Appl. No.: 18/472,785

(22) Filed: Sep. 22, 2023

Related U.S. Application Data
(63) Continuation of application No. PCT/JP22/13489, filed on Mar. 23, 2022.

(30) Foreign Application Priority Data
Mar. 24, 2021 (JP) 2021-050244

(51) Int. Cl. A63F 13/533; A63F 13/58

(52) U.S. Cl. CPC A63F 13/533; A63F 13/58; A63F 13/35

(57) ABSTRACT

Provided is a program in which any of a plurality of stage-raising conditions different from each other is set for any stage, the program causing a computer to execute steps of: determining, upon acceptance of a player input for selecting a target game medium from among a game medium (or media), the stage of the target game medium being to be raised, whether a first stage-raising condition set for the stage of the target game medium is satisfied; determining whether a stage-raising condition set for the next stage thereof is a second stage-raising condition, in the case where it is determined that the first stage-raising condition is satisfied; and displaying a transition-instruction accepting unit for making the transition to a screen for presenting the second stage-raising condition, in the case where it is determined that the stage-raising condition set for the next stage is the second stage-raising condition.

### TECHNICAL FIELD

The present invention relates to a program etc. for a game and particularly relates to a program etc. used in a game in which it is possible to raise the stage of a game medium.

### BACKGROUND ART

A number of games in which the parameters of a game medium possessed by a player are raised and enhanced have been released. Among such games, there is a game system that realizes processing for raising a plurality of different types of parameters up to the maximum values all at once (PTL 1).

### CITATION LIST

### Patent Literature

[PTL 1] Publication of Japanese Patent No. 6639102

### SUMMARY OF INVENTION

### Technical Problem

However, in the case where a parameter set for a game medium can take a plurality of values, it is not always the case that a player desires to raise the parameter up to the maximum value all at once. In a game in which different raising conditions are set for one kind of parameter in accordance with the stages thereof, a system for raising the the stage up to a stage desired by a player, by a plurality of stages all at once has not yet been realized.

The present invention has been made to solve the above-described problem, and a main object thereof is to provide a program etc. in which, when a game medium for which a plurality of stage-raising conditions that are different from each other have been set is to be raised by a plurality of stages all at once, display is performed for raising the stage to the stage desired by a player, with a simple operation.

### Solution to Problem

1. In order to achieve the above-described object, according to one aspect, the present invention provides a program that is used in a game capable of raising a stage of a game medium stored in association with player identification information of a player, any of a plurality of stage-raising conditions different from each other being set for any stage, the program causing a computer to execute: a step of determining, upon acceptance of a player input for selecting a target game medium from among a game medium (or media) stored in association with the player identification information, the stage of the target game medium being to be raised, whether a first stage-raising condition set for the stage of the target game medium is satisfied; a step of determining whether a stage-raising condition set for the next stage thereof is a second stage-raising condition, in the case where it is determined that the first stage-raising condition is satisfied; and a step of displaying a transition-instruction accepting unit for making a transition to a screen for presenting the second stage-raising condition, in the case where it is determined that the stage-raising condition set for the next stage is the second stage-raising condition, wherein one of the first stage-raising condition and the second stage-raising condition includes consuming a game medium selected by the player.

2. In the program cited in Item 1, the step of determining whether the first stage-raising condition is satisfied may further include a step of determining that the first stage-raising condition is satisfied, upon acceptance of a player input for selecting a predetermined consumption game medium.

3. In the program cited in Item 2, it is also possible to cause the computer to further execute: a step of displaying a stage-raising-instruction accepting unit with respect to the stage for which the second stage-raising condition has been set, upon acceptance of a player input to the transition-instruction accepting unit, which is displayed when it is determined that the first stage-raising condition is satisfied; and a step of consuming the consumption game medium selected for satisfying the first stage-raising condition and a consumption game medium for satisfying the second stage-raising condition, upon acceptance of an input to the stage-raising-instruction accepting unit.

4. In the program cited in Item 2 or 3, the step of determining whether the first stage-raising condition is satisfied can further include a step of displaying a stage to which raising is possible if the first stage-raising condition is satisfied, upon acceptance of a player input for selecting a predetermined consumption game medium; and the step of displaying the transition-instruction accepting unit, which is used for making a transition to the screen for presenting the second stage-raising condition, can further include a step of displaying a stage to which raising is possible if the second stage-raising condition is satisfied, in the case where it is determined that the second stage-raising condition is satisfied.

5. In the program cited in one of Items 1 to 4, the second stage-raising condition may be determined on the basis of whether a game medium, which is decided on the basis of a raising-target stage for which the second stage-raising condition has been set, satisfies a predetermined condition.

6. In the program cited in one of Items 1 to 5, it is also possible to cause the computer to further execute a step of displaying a game medium required to satisfy the second stage-raising condition, upon acceptance of a player input with respect to the transition-instruction accepting unit.

7. In the program cited in Item 1, the step of determining whether the first stage-raising condition is satisfied may further include a step of accepting a player input for selecting a raised stage for which the first stage-raising condition has been set, and a step of determining that the first stage-raising condition is satisfied in the case where a game medium decided on the basis of the selected stage satisfies a predetermined condition; and it is also possible to cause the computer to further execute, upon acceptance of a player input with respect to the displayed transition-instruction accepting unit, which is used for making a transition to the screen for presenting the second stage-raising condition, a step of accepting a player input for selecting a consumption game medium, and a step of determining that the second stage-raising condition is satisfied in the case where the selected consumption game medium satisfies a predetermined condition.

8. In the program cited in Item 6 or 7, the step of determining whether the first stage-raising condition is satisfied can further include a step of displaying a stage to which raising is possible if the first stage-raising condition is satisfied; and the step of displaying the transition-instruction accepting unit, which is used for making a transition to the screen for presenting the second stage-raising condition, can further include a step of displaying a stage to which raising is possible if the second stage-raising condition is satisfied.

9. In the program cited in one of Items 1 to 8, the target game medium and the consumption game medium that is selected by the player input may be assigned to the player on the basis of a predetermined lottery process.

10. In the program cited in one of Items 1 to 9, the first stage-raising condition can be set for a plurality of stages; and the step of determining whether the first stage-raising condition is satisfied can be executed with respect to each of the stages for which the first stage-raising condition has been set, until it is determined that the stage-raising condition set for the next stage is the second stage-raising condition.

According to another aspect, the present invention provides an electronic device that is used in a game capable of raising a stage of a game medium stored in association with player identification information of a player, any of a plurality of stage-raising conditions different from each other being set for any stage, the electronic device determining, upon acceptance of a player input for selecting a target game medium from among a game medium (or media) stored in association with the player identification information, the stage of the target game medium being to be raised, whether a first stage-raising condition set for the stage of the target game medium is satisfied; determining whether a stage-raising condition set for the next stage thereof is a second stage-raising condition, in the case where it is determined that the first stage-raising condition is satisfied; and displaying a transition-instruction accepting unit for making a transition to a screen for presenting the second stage-raising condition, in the case where it is determined that the stage-raising condition set for the next stage is the second stage-raising condition, wherein one of the first stage-raising condition and the second stage-raising condition includes consuming a game medium selected by the player.

According to still another aspect, the present invention provides a method that is used in a game capable of raising a stage of a game medium stored in association with player identification information of a player, any of a plurality of stage-raising conditions different from each other being set for any stage, the method causing a computer to execute: a step of determining, upon acceptance of a player input for selecting a target game medium from among a game medium (or media) stored in association with the player identification information, the stage of the target game medium being to be raised, whether a first stage-raising condition set for the stage of the target game medium is satisfied; a step of determining whether a stage-raising condition set for the next stage thereof is a second stage-raising condition, in the case where it is determined that the first stage-raising condition is satisfied; and a step of displaying a transition-instruction accepting unit for making a transition to a screen for presenting the second stage-raising condition, in the case where it is determined that the stage-raising condition set for the next stage is the second stage-raising condition, wherein one of the first stage-raising condition and the second stage-raising condition includes consuming a game medium selected by the player.

### Advantageous Effects of Invention

According to the present invention, it is possible to raise the stage of a game medium to a stage desired by a player all at once with a simple operation.

### BRIEF DESCRIPTION OF DRAWINGS

FIG. 1 is a configuration diagram of a system according to an embodiment of the present invention.

FIG. 2 is a hardware configuration diagram of electronic devices according to the embodiment of the present invention.

FIG. 3 is a functional block diagram of the electronic devices according to the embodiment of the present invention.

FIG. 4 shows one example of a game screen according to the embodiment of the present invention.

FIG. 5 shows one example of the game screen according to the embodiment of the present invention.

FIG. 6 shows one example of the game screen according to the embodiment of the present invention.

FIG. 7 shows one example of the game screen according to the embodiment of the present invention.

FIG. 8 shows one example of the game screen according to the embodiment of the present invention.

FIG. 9 is a flowchart showing information processing according to the embodiment of the present invention.

FIG. 10 is a flowchart showing information processing according to the embodiment of the present invention.

FIG. 11 is a flowchart showing information processing according to the embodiment of the present invention.

FIG. 12 is a flowchart showing information processing according to the embodiment of the present invention.

FIG. 13 shows one example of the game screen according to the embodiment of the present invention.

FIG. 14 is a flowchart showing information processing according to the embodiment of the present invention.

FIG. 15 is a flowchart showing information processing according to the embodiment of the present invention.

### DESCRIPTION OF EMBODIMENT

A game system 1 according to an embodiment of the present invention will be described below with reference to the drawings. In this specification, for convenience of description, there are cases where descriptions that are more detailed than necessary are omitted. For example, there are cases where detailed descriptions of matters that are already well known and repeated descriptions of substantially the same configurations are omitted.

Although the game system 1 can be realized by a system in which a plurality of electronic devices are connected via a network, the game system 1 can also be realized by one electronic device. Here, a description will be given of an embodiment in which the system connected to the network is used.

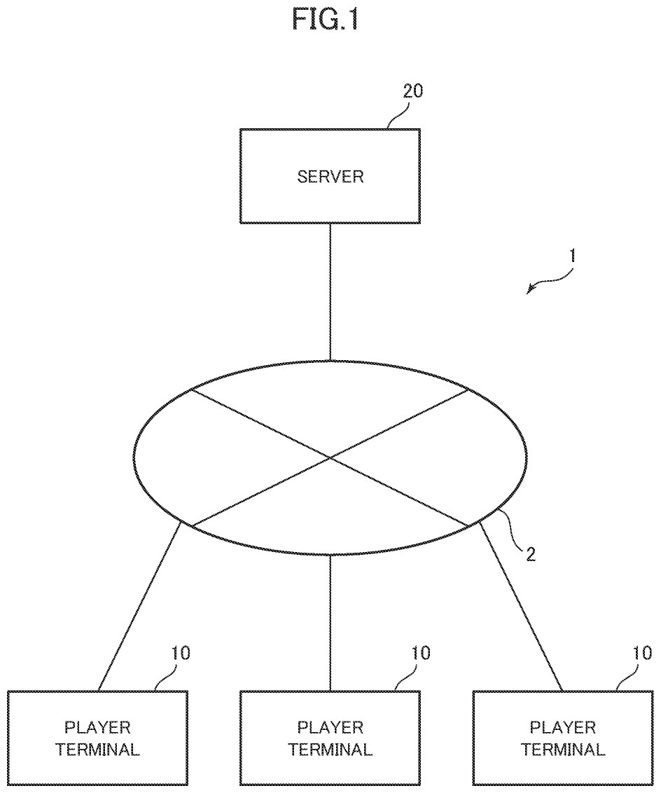

FIG. 1 shows one example of the overall configuration of the game system according to the embodiment of the present invention. As shown in FIG. 1, the game system 1 includes a plurality of player terminals 10 and a server 20, and the player terminals 10 and the server 20 are connected to a network 2, such as the Internet, so as to be able to communicate with each other. Note that a description will be given on the assumption that the game system 1 of this embodiment is a server-client system.

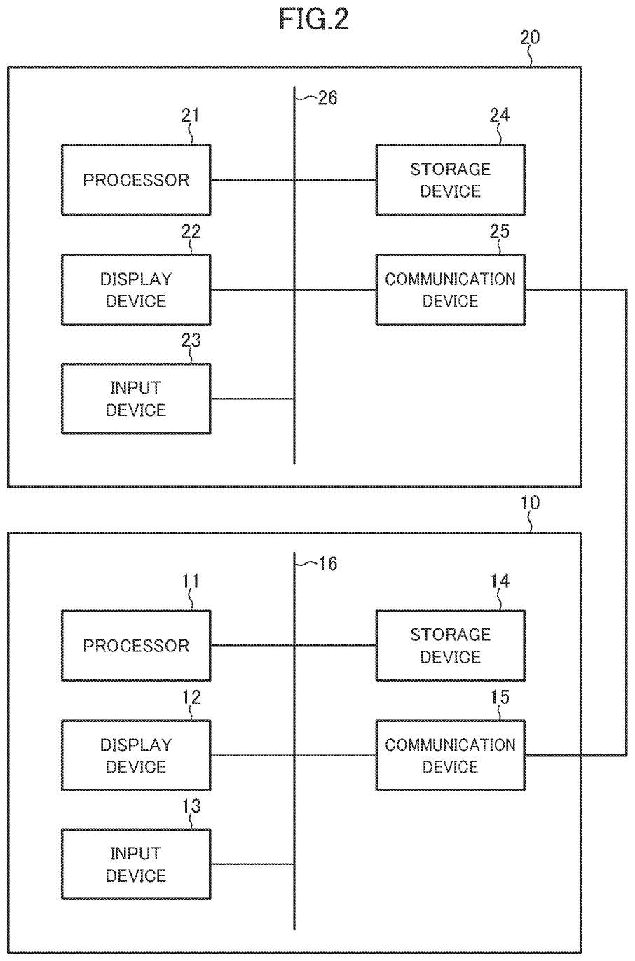

FIG. 2 is a block diagram showing the hardware configurations of the server 20 and each of the player terminals 10 according to the embodiment of the present invention. Each of the player terminals 10 includes a processor 11, a display device 12, an input device 13, a storage device 14, and a communication device 15. These individual constituent devices are connected via a bus 16. Note that it is assumed that interfaces are interposed as needed between the bus 16 and the individual constituent devices. Although the player terminal 10 is a smartphone in this embodiment, the player terminal 10 can also be an electronic device such as a computer or a game machine, as long as the electronic device includes the configuration described above.

Similarly, the server 20 includes a processor 21, a display device 22, an input device 23, a storage device 24, and a communication device 25. These individual constituent devices are connected via a bus 26. Note that it is assumed that interfaces are interposed as needed between the bus 26 and the individual constituent devices. In this embodiment, the server 20 is realized by a computer.

The processors 11 and 21 control the overall operations at the player terminal 10 and the server 20, respectively, and are, for example, CPUs. Note that electronic circuits such as MPUs may also be used as the processors 11 and 21. The processors 11 and 21 execute various kinds of processing by loading and executing programs and data stored in the storage devices 14 and 24, respectively. In one example, the processors 11 and 21 are each configured of a plurality of processors.

The display devices (displays) 12 and 22 display application screens etc. to a user (player) of the player terminal 10 and a user (administrator) of the server 20 according to control of the processors 11 and 21, respectively. Although the display devices 12 and 22 are preferably liquid crystal displays, it is also possible to adopt displays using organic EL, plasma displays, or the like.

The input devices 13 and 23 are user interfaces for accepting inputs from the users to the player terminal 10 and the server 20, and are, for example, touchscreens, touchpads, keyboards, or mouses. In this embodiment, since the player terminal 10 is a smartphone, the player terminal 10 includes a touchscreen as the input device 13, the touchscreen also functions as the display device 12, and the display device 12 and the input device 13 have an integrated structure. It is also possible that the display device 12 and the input device 13 have separate forms disposed at different positions. Since the server 20 is a computer, it is assumed that the server 20 includes a keyboard and a mouse as the input device and includes a liquid crystal display as the display device.

The storage devices 14 and 24 are storage devices that are provided for general smartphones and computers and that include RAMS, which are volatile memories, and ROMs, which are non-volatile memories. The storage devices 14 and 24 can also include external memories. For example, the storage device 14 stores a Web application (browser) and a native application (game program) for executing a game, and the storage device 24 stores a server game program. The Web application etc. are activated in accordance with user operations carried out on the player terminal 10 and are executed on an operating system (OS) implemented in advance in the player terminal 10. The server game program includes functions and various kinds of data for performing information processing so as to properly proceed with games on the Web application etc. executed at each player terminal serving as a client.

In one example, the storage devices 14 and 24 are storage devices that are provided for general smartphones and computers and include magnetic storage devices and storage devices that use RAMS, which are volatile memories, and flash memories, which are non-volatile memories, such as eMMCs, UFSs, or SSDs. The storage devices 14 and 24 can also include external memories. For example, the storage device 14 stores a browser program and a game program, and the storage device 24 stores a server game program. The browser program and the game program are activated in accordance with user operations carried out on the player terminal 10 and are executed on an operating system (OS) implemented in advance in the player terminal 10. The server game program includes functions and various kinds of data for performing information processing so as to properly proceed with games on the browser program and the game program executed at each player terminal serving as a client. Furthermore, as the storage devices, it is also possible to use databases physically separated from the player terminal 10 and the server 20.

The communication devices 15 and 25 send data to and receive data from other devices via the network 2 (not shown in FIG. 2). For example, the communication devices 15 and 25 perform mobile communication or wireless communication, such as that using a wireless LAN, to connect to the network 2. The player terminal 10 uses the communication device 15 to communicate with the server 20 via the network. The communication devices 15 and 25 may perform wired communication using an Ethernet (registered trademark) cable or the like.

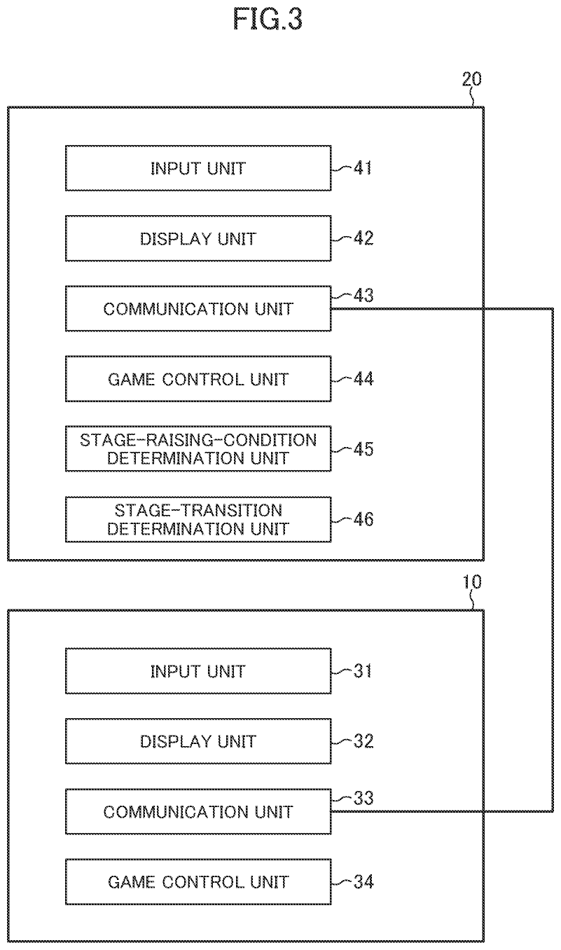

FIG. 3 shows one example of a functional block diagram of the player terminal 10 and the server 20 according to the embodiment of the present invention. The player terminal 10 includes an input unit 31, a display unit 32, a communication unit 33, and a game control unit 34, and the server 20 includes an input unit 41, a display unit 42, a communication unit 43, a game control unit 44, a stage-raising-condition determination unit 45, and a stage-transition determination unit 46.

In the embodiment, these functions are realized when the processors 11 and 21 execute programs. For example, the executed programs are the browser program and the game program stored in the storage devices 14 and 24. Since the various kinds of functions are realized by loading the programs, as described above, a portion or the entirety of one part (function) may be included in another part. Alternatively, these functions may be realized by means of hardware by configuring electronic circuits or the like each realizing a portion or the entirety of each of the functions.

The input units 31 and 41 are configured by using the input devices 13 and 23, respectively, and accept inputs from the users to the player terminal 10 and the server 20. The player terminal 10 and the server 20 accept player inputs by means of the input units 31 and 41. In this embodiment, in the player terminal 10, a touch detection function generally provided for a smartphone, which is provided with the touchscreen, can be used.

The display unit 32 displays game screens on the display device 12 and displays game screens in accordance with the proceeding of the game and user operations. The game control unit 34 performs control processing for executing the game of this embodiment and stores various kinds of data required for the processing. In this embodiment, the game control unit 34 uses the browser program to perform processing of information to be input from or output to the player, processing of signals to be sent to or received from the server 20, etc. In the case where a game application is installed on the player terminal 10 to execute a game, the game control unit 34, which is realized by the game application, executes various kinds of information processing, such as game progression, data management, etc., for executing the game.

The display unit 42 displays a management screen for a game administrator, as needed, on the display device 22. The game control unit 44 performs processing for the game executed at the player terminal 10 of this embodiment. In one example, when the browser is activated in the player terminal 10, the game control unit 34 is realized, and the server 20 is accessed in order to proceed with the game, the game control unit 44 sends data thereto and receives data therefrom regularly or as needed, to proceed with the game. For example, the game control unit 44 stores various kinds of data etc. required for the control processing for executing the game of this embodiment and appropriately provides such data to the player terminal 10. The various kinds of data include: raising conditions for raising the stages of individual game media; game media possessed by a player and stored in association with player identification information of the player; parameters of the game media; etc.

It is assumed that a plurality of stages are set for a game medium, and any of a plurality of stage-raising conditions, different from each other, is set in advance for any of the stages and is stored in the game control unit 44. The stage is one of the parameters of the game medium, and the game medium can be strengthened by raising the stage.

In this embodiment, it is assumed that the stage is an upper-limit release stage. The parameters of the game medium include an attacking power, hit points (HP), a level, a level cap, and an upper-limit release stage, and the attacking power and the HP are decided on the basis of the level of the game medium. The level of the game medium can be raised when certain requirements are met but can be raised only up to the level cap decided on the basis of the upper-limit release stage of the game medium. By raising the upper-limit release stage, it is possible to raise the level cap and to further strengthen the game medium.

The stage may be used for not only just raising the parameter of the game medium but also performing enhancement and evolution, e.g., addition of an element, such as a new parameter, and a change to a different parameter, or the stage may be used for all of the descriptions above or a partial combination of the descriptions above.

A stage-raising condition for raising the stage is set and stored in advance for each stage. The same raising condition may be set for a plurality of stages. In this embodiment, a first stage-raising condition is set for upper-limit release stages 0 to 2, and a second stage-raising condition is set for upper-limit release stages 3 and 4. Different raising conditions are set in the first stage-raising condition and the second stage-raising condition.

The input unit 31 of the player terminal 10 accepts a player input for selecting a target game medium of which the stage is to be raised, from among game media stored in association with input player identification information. The stage-raising-condition determination unit 45 determines whether the stage-raising condition set for the stage of the target game medium is satisfied.

In the case where the stage-raising-condition determination unit 45 determines that the first stage-raising condition is satisfied, the stage-transition determination unit 47 determines whether the stage-raising condition set for the next stage is the second stage-raising condition. As specific processing for this determination, although it is possible to compare the stage-raising condition at that time and the stage-raising condition set for the next stage or to make the determination on the basis of the stage-raising condition itself set for the next stage, it is also possible to realize the determination by determining whether the next stage is a stage for which the second stage-raising condition has been set, for example. In this embodiment, since only two kinds of stage-raising conditions are used, it is assumed that, when the next stage is the upper-limit release stage 3, which is the lowest stage for which the second stage-raising condition has been set, it is determined that the stage-raising condition set for the next stage is the second stage-raising condition.

In the case where it is determined that the stage-raising condition set for the next stage is the second stage-raising condition, the game control unit 44 makes the display unit 32 of the player terminal 10 display a transition-instruction accepting unit for making the transition to a screen for presenting the second stage-raising condition. The transition-instruction accepting unit is displayed in the case where it is determined that the stage-raising condition set for the next stage is the second stage-raising condition, thereby making it possible to notify the player that the stage-raising condition will be changed.

It is also possible to further set a third stage-raising condition. It is obvious to a person skilled in the art that stage-raising processing from a stage for which the second stage-raising condition has been set to a stage for which the third stage-raising condition has been set can be realized by applying, thereto, the same processing as stage-raising processing from a stage for which the first stage-raising condition has been set to a stage for which the second stage-raising condition has been set. The same applies to a case in which four or more stage-raising conditions are set.

Here, the stage-raising condition set for each stage is a condition for raising that stage to the next stage. The stage-raising conditions for raising the upper-limit release stages 0 to 2 to the upper-limit release stages 1 to 3 are the first stage-raising condition, and the stage-raising conditions for raising the upper-limit release stages 3 and 4 to the upper-limit release stages 4 and 5 are the second stage-raising condition. The stage-raising condition set for each stage may be a condition for raising the stage to the stage for which the stage-raising condition has been set. In that case, it is obvious to a person skilled in the art that this can be realized by the same information processing as in this embodiment.

The first stage-raising condition is a condition that a predetermined consumption game medium selected by the player is consumed, and the second stage-raising condition is a condition that a game medium that is decided not by selection by the player but on the basis of a raising-target stage is consumed. Specifically, the first stage-raising condition is a condition that one consumption game medium that is the same as a target game medium selected by the player is consumed, and the second stage-raising condition is a condition that a game medium that is not decided by selection by the player but is possessed by the player and determined in advance is consumed. In this specification, there are cases where a game medium to be consumed is called a material, and a target game medium is called a base game medium.

The difference between the first stage-raising condition and the second stage-raising condition is that an item to be consumed can be selected by the player in the first stage-raising condition, and an item to be consumed cannot be selected by the player in the second stage-raising condition. For example, it is also possible that the first stage-raising condition set for the upper-limit release stage 1 is that one game medium that is the same as the target game medium is consumed, and the first stage-raising condition set for the upper-limit release stage 2 is that two game media are consumed. The stage-raising conditions set for the upper-limit release stages 1 and 2 are both the first stage-raising conditions because the consumption game medium (or media) can be selected by the player even though the number of game media to be consumed is different therebetween. Furthermore, in another embodiment, in the case where the number of game media to be consumed or the types thereof are different, different stage-raising conditions may be used.

When a player input to the transition-instruction accepting unit is accepted, the transition-instruction accepting unit being displayed after it is determined that the stage-raising condition set for the next stage is the second stage-raising condition, a stage-raising-instruction accepting unit for a stage for which the second stage-raising condition has been set is displayed. When a player input to this accepting unit is accepted, a consumption game medium selected in order to satisfy the first stage-raising condition and a consumption game medium for satisfying the second stage-raising condition are consumed.

In this way, consumption of a consumption game medium is not executed until a stage-raising instruction is accepted, thus allowing the player to consider a desired upper-limit release stage. In order to determine that the stage-raising condition is satisfied, consumption of a consumption game medium is not required. It is also possible to set, as a tentative stage-raising condition, a condition that a consumption game medium required to satisfy the stage-raising condition is selected by the player or is possessed by the player and to determine that the stage-raising condition is satisfied when the tentative stage-raising condition is satisfied. When an identifier of a game medium is stored in association with the player identifier, it is possible to determine that the player possesses the game medium.

When it is determined that the stage-raising condition set for a raising-target stage is satisfied, the game control unit 44 manages the game medium that is required to satisfy the stage-raising condition, as a tentatively consumed game medium. In this embodiment, the tentatively consumed game medium is deleted from a player's possessed-game-medium list and is stored in a tentatively consumed game-medium list.

If it is determined that stage-raising conditions set for a plurality of stages are satisfied, all game media required to satisfy the individual stage-raising conditions are stored, as tentatively consumed game media, in association with the individual stages. In this embodiment, at the time of raising of the stage for which the first stage-raising condition has been set, a consumption game medium selected by the player is stored in the tentatively consumed game-medium list, and, at the time of raising of the stage for which the second stage-raising condition has been set, a predetermined consumption game medium is stored in the tentatively consumed game-medium list.

Before a stage-raising instruction is accepted, if the player cancels tentative stage raising or performs a player input for returning to the previous stage, the consumption game medium corresponding to the cancelled stage raising is deleted from the tentatively consumed game list and is returned to the player's possessed-game-medium list. When a stage-raising instruction is accepted, the consumption game medium is consumed and is deleted from the tentatively consumed game-medium list, thus being set in a consumed state.

When it is determined that the stage-raising condition set for a stage-raising-target stage is satisfied, a stage to which raising is possible (tentative upper-limit release stage) is displayed. When a player input to the transition-instruction accepting unit is accepted, and it is determined that the second stage-raising condition is satisfied, a stage to which raising is possible (tentative upper-limit release stage) is displayed due to the fact that the second stage-raising condition is satisfied. It is determined that the predetermined condition is satisfied in the case where the player possesses a game medium decided on the basis of the raising-target stage.

Although a target game medium and a consumption game medium that is selected by a player input can be given to the player on the basis of a predetermined lottery process, and a game medium decided on the basis of the raising-target stage can be given to the player in accordance with the result of a gameplay, both of the game media may also be given to the player in accordance with the result of a lottery process or a gameplay.

In this embodiment, an upper-limit release stage is set for a target game medium and a consumption game medium that is selected by a player input. A consumption game medium that is selected by a player input can become a target game medium serving as a target on which upper-limit releasing is performed, and can be selected as a consumption game medium for performing upper-limit releasing on a target game medium. For example, in the case where a plurality of identical weapon items are possessed, if one of the weapon items has already been subjected to upper-limit releasing by one stage, it is possible to select this weapon item as a target game medium on which upper-limit releasing is to be further performed and to select the other weapon item on which upper-limit releasing has not yet been performed, as a consumption game medium.

On the other hand, an upper-limit release stage is not set for a game medium that is not decided by selection by the player but is decided in advance on the basis of the raising-target stage. Since such a game medium is a game medium (material item) to be consumed to raise the stage of a game medium serving as a target game medium, upper-limit releasing cannot be performed thereon. Therefore, to perform upper-limit releasing on a target game medium, it is not always necessary to make the player select which game medium is to be consumed.

When one of the raising conditions for the plurality of upper-limit release stages is set to consuming a game medium that is provided on the basis of a lottery process, it is possible that the player does not waste a game medium that is redundantly obtained through a lottery and makes effective use of the game medium for enhancement thereof, whereby the motivation to perform a lottery can be improved. Furthermore, when the other raising condition is set to consuming a game medium obtained through a gameplay, the player is made to perform not only a lottery but also a gameplay in order to strengthen game media, whereby it is possible to increase the active rate of the game system and to provide a more active game environment.

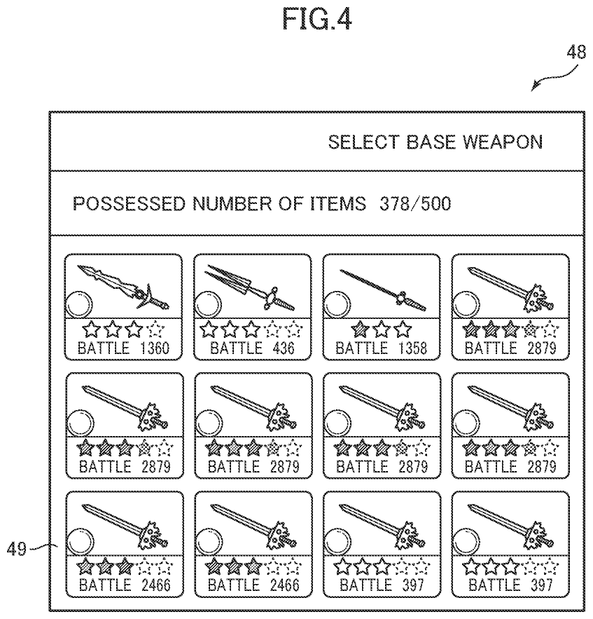

FIG. 4 shows one example of a game screen 48 that accepts a player input for selecting a target game medium of which the stage is to be raised, from among game media possessed by the player. The game screen 48 presents a list of images 49 indicating, among game media (weapons) possessed by the player, game media on which stage raising (upper-limit releasing) can be performed. As specific information processing, when the player performs a player input for requesting to display an upper-limit-releasing-target game-medium selection screen via the input unit 31 of the player terminal 10, the game control unit 44 of the server 20 reads game media stored in association with the player identifier of the player, decides game media of which the upper-limit release stages have not yet reached the maximum value, generates game-screen information including the images 49 that indicate the game media serving as upper-limit releasing targets, and sends the game-screen information to the player terminal 10. When the game-screen information is received, the player terminal 10 causes the game screen 48 to be displayed on the display unit 32.

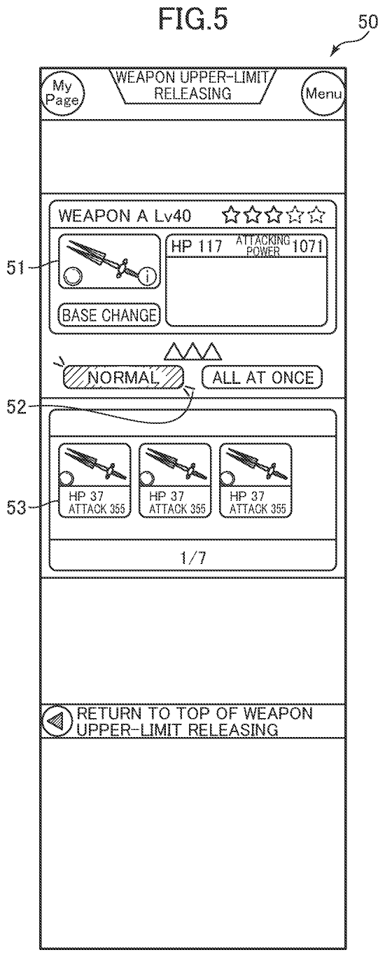

In this embodiment, although a condition that a player input by the player for selecting, as a consumption game medium, one game medium that is the same as a game medium (base game medium) serving as an upper-limit releasing target is accepted and the selected consumption game medium (material game medium) is consumed is set as the first stage-raising condition, it is also possible to consume a plurality of the same game media as a game medium (base game medium) serving as an upper-limit releasing target or to consume a different game medium therefrom. FIG. 5 shows one example of a game screen for making the player select a consumption game medium. When a player input for selecting a target game medium of which the stage is to be raised is accepted, the game control unit 44 makes the player terminal 10 display a game screen 50 shown in FIG. 5.

Here, the player can use a mode selection button 52 to choose either a normal mode in which only one stage is raised or an all-at-once mode in which raising processing of a plurality of stages is performed all at once. The game screen is a screen in which the normal mode has been chosen, an image 51 indicating a target game medium (weapon A) is displayed thereon, and images 53 indicating game media serving as candidates for a consumption game medium are displayed thereon. The player can make a selection by touching the image of any consumption game medium. When a consumption game medium is selected by the player, for example, a confirmation screen for allowing the player to confirm the selection is displayed (not shown), and, when a confirmation input is performed by the player, the selected consumption game medium is consumed, and the upper-limit release stage of the target game medium is raised by one.

Consuming a game medium can be realized, for example, by deleting identification information of the game medium stored in association with the player identifier or by setting the status of the game medium associated with the player identifier to “consumed” in a player's-possession-state status, to clear the possessed state, thereby making it unable to be used thereafter.

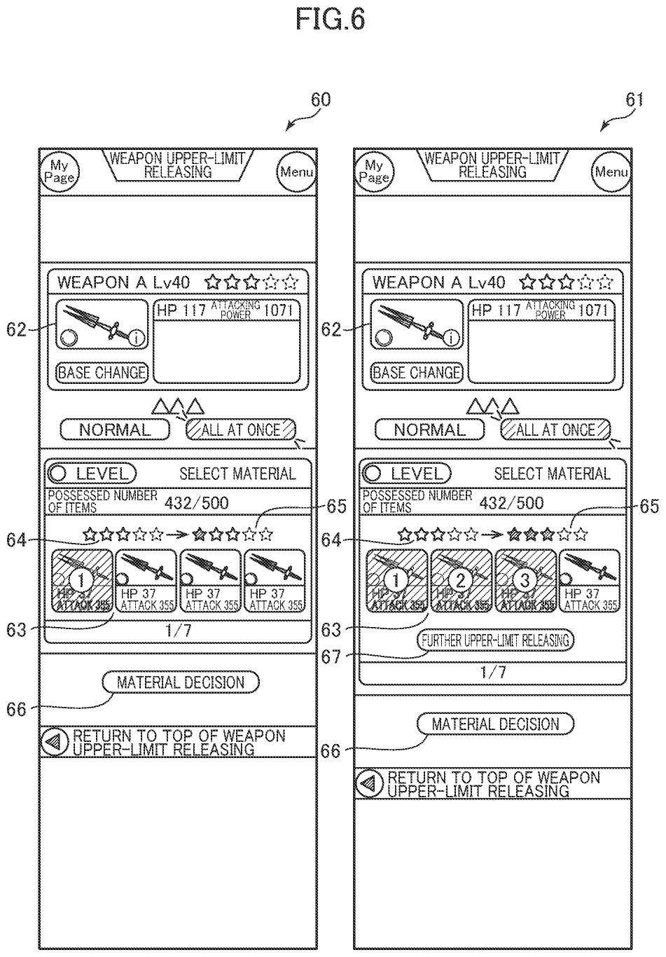

FIG. 6 shows one example of a game screen in the one-time mode. With respect to a target game medium 62 of which the stage is to be raised, a game screen 60 shows a state in which one consumption game medium 63 has been selected, and a game screen 61 shows a state in which three consumption game media 63 have been selected. An upper-limit release stage display 64 indicates the upper-limit release stage of the target game medium at that time, and a tentative upper-limit release stage display 65 indicates an upper-limit release stage (tentative upper-limit release stage) to which raising is possible with the consumption game medium (or media) selected by the player. Here, the current upper-limit release stage of the game medium 62 is 0, and the game screen 60 indicates that raising the stage up to an upper-limit release stage 1 can be performed by consuming one consumption game medium, and the game screen 61 indicates that raising the stage up to an upper-limit release stage 3 can be performed by consuming three consumption game media.

Accordingly, the player selects a game medium (or media) required to achieve a desired upper-limit release stage, while confirming stage raising up to the desired upper-limit release stage with the use of a consumption game medium (or media) and the raised upper-limit release stage, without involving a game-screen transition, and then performs a player input on a material (consumption game medium) decision button 66, thereby making it possible to easily execute raising of a plurality of stages all at once.

In the game screen 61, when raising the stage to the upper-limit release stage 3 is indicated by selecting the three consumption game media, a transition-instruction accepting unit 67 for instructing a game-screen transition for further raising the stage to the next upper-limit release stage 4 is displayed. Accordingly, it is possible to notify the player that a different stage-raising condition is required in order to perform the next upper-limit releasing, and to make a transition to a game screen suitable for presenting the different stage-raising condition, on the basis of an input from the player.

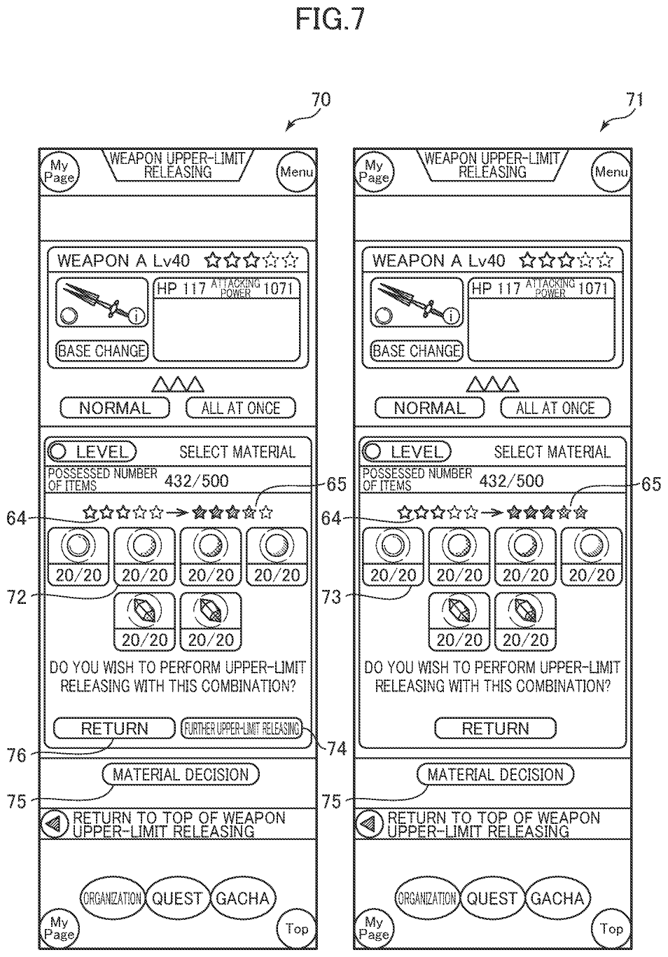

FIG. 7 shows one example of a game screen displayed after a screen transition made when the player touches the transition-instruction accepting unit 67. First, a game screen 70 is displayed to present, to the player, consumption game media 72 required for raising the stage to the upper-limit release stage 4. This is a screen displayed in the case where it is determined that the second stage-raising condition is satisfied. The player does not need to select the consumption game media 72. Thus, in this embodiment, an accepting unit for accepting a player's selection input for selecting the consumption game media 72 is not displayed. When the player performs a player input to a screen-transition-instruction accepting unit 74 for instructing a screen transition for displaying further tentative upper-limit releasing and a condition therefor, a game screen 71 is displayed. When a return button 76 is touched, the screen returns to the game screen 61 while lowering the tentative upper-limit release stage by one so as to return to the previous state.

As described earlier, when it is determined that the stage-raising condition set for the stage-raising-target stage is satisfied, the game control unit 44 deletes a consumption game medium required to satisfy the stage-raising condition from the player's possessed-game-medium list, and stores the consumption game medium in the tentatively consumed game-medium list in association with the stage. When the player touches the return button 76, the consumption game medium associated with the returning-target stage is deleted from the tentatively consumed game-medium list and is returned to the player's possessed-game-medium list.

In this embodiment, the transition-instruction accepting unit has two kinds of units, i.e., the accepting unit 67, which is displayed when the next stage-raising condition is different, and the accepting unit 74, which is displayed even when the next stage-raising condition is not different. The accepting unit 74 is displayed, for example, in the case where the tentative upper-limit release stage is 4, and the next upper-limit release stage is 5, and the stage-raising condition for both stages is the second stage-raising condition. However, since more consumption game media are required to raise the upper-limit release stage to 5, the game screen is transitioned in order to present the consumption game media to the player.

In the game screen 71, consumption game media 73 required for raising to the upper-limit release stage 5 are presented. When the player performs a player input to the material decision button 75, a plurality of stages can be raised all at once up to the stage displayed in the tentative upper-limit release stage. Specifically, when the material decision button 75 is touched in the game screen 70, the stage-raising processing up to the upper-limit release stage 4 is executed, and, when the material decision button 75 is touched in the game screen 71, the stage-raising processing up to the upper-limit release stage 5 is executed.

As described earlier, in this embodiment, even though the upper-limit release stage is a single parameter set for a game medium, the stage-raising condition set for the upper-limit release stages 0 to 2 and the stage-raising condition set for the upper-limit release stages 3 and 4 are different. By using the above-described aspect, even when stage raising is performed over stages for which the different stage-raising conditions have been set, it is possible to perform stage-raising processing all at once up to the stage desired by the player, with a simple input operation by the player, while notifying the player that the stage-raising condition will be changed.

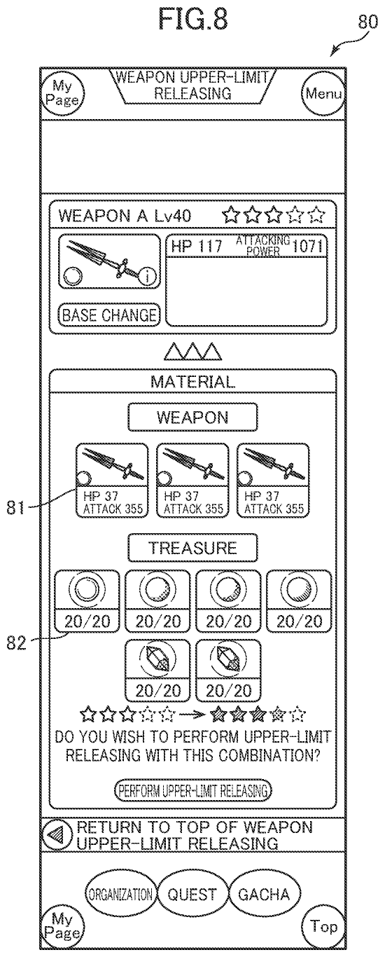

FIG. 8 shows one modification of a game screen displayed after a screen transition made when the player performs a player input by touching the transition-instruction accepting unit 67. Although, in the example shown in FIG. 7, the consumption game media 72 required for raising the stage up to the upper-limit release stage 4 are only game items other than weapons, FIG. 8 presents, to the player, that weapons and game items (treasures) other than the weapons are both required to be consumed.

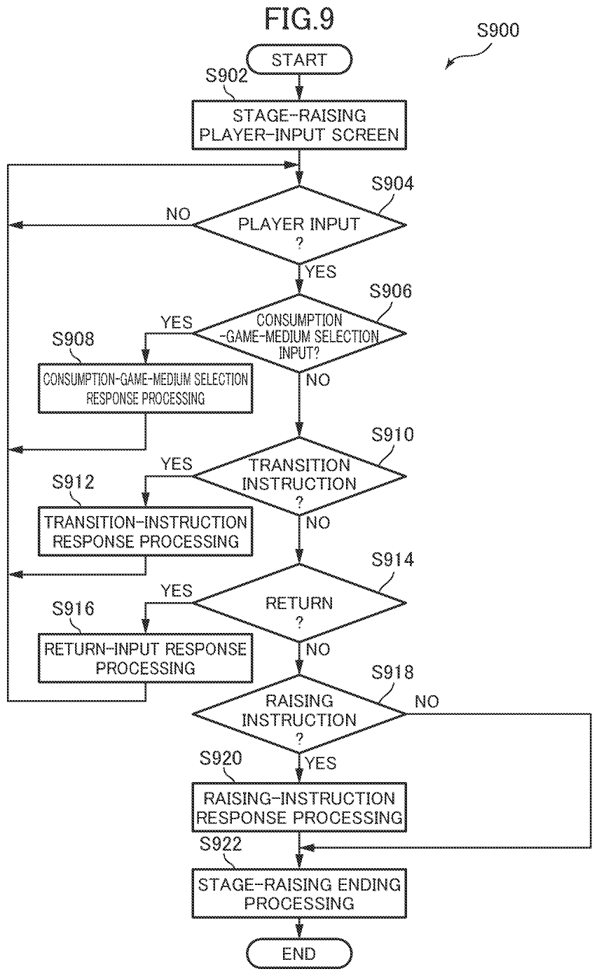

Next, one example of game-medium stage-raising processing in the all-at-once mode executed in the game system 1 according to the embodiment of the present invention will be described by using flowcharts shown in FIGS. 9 to 12. The game to be executed by the game system can be any type of game as long as the game can be played by the player by using at least one game medium selected from among a plurality of game media. The player attempts to advantageously proceed with the game by strengthening the game medium. As one aspect of the game-medium enhancement, the upper-limit release stage thereof can be raised.

When the player sends a request to raise the upper-limit release stage of the game medium to the server 20 via the player terminal 10, the server 20 causes the target-game-medium selection screen, which is shown in FIG. 4, to be displayed on the display unit 32 of the player terminal 10. Then, when the player performs a player input for selecting a stage-raising target game medium, the server 20 sends, to the player terminal 10, information for displaying a stage-raising player-input screen for the selected target game medium. Then, when the player chooses the all-at-once mode, the player terminal 10 displays the player-input screen 60 (FIG. 6) for stage raising of the target game medium on the display unit 32 (S902).

When the player performs a player input on the player-input screen 60 (S904), the player terminal 10 accepts this player input and sends it to the server 20. The server 20 executes processing based on the received player input. The server 20 determines whether the player input is a consumption-game-medium selection input (S906). In the case where the determination result is affirmative, the server 20 executes consumption-game-medium selection response processing (S908) and returns to a standby state for the next player input (S904).

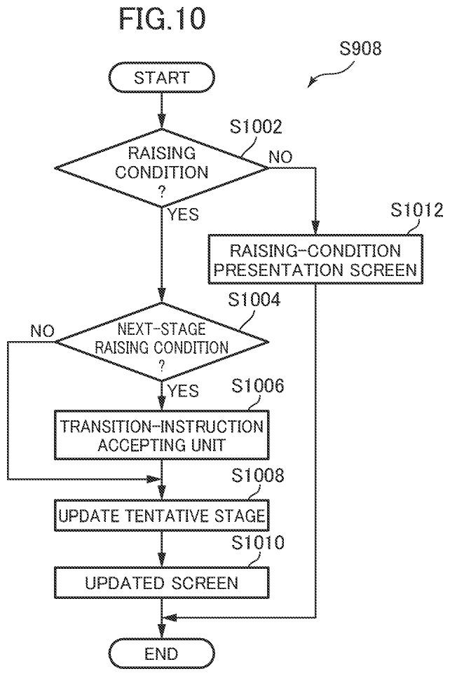

FIG. 10 shows more detailed processing of the consumption-game-medium selection response processing (S908). It is determined whether the consumption game medium selected by the consumption-game-medium selection input satisfies the stage-raising condition set for the stage of the target game medium (S1002).

The determination-target stage of the target game medium is the tentative upper-limit release stage of this target game medium when the raising-condition determination processing (S1002) is executed. The tentative upper-limit release stage is the upper-limit release stage in the case where stage-raising-instruction response processing (S920) is executed before a consumption-game-medium selection input is performed. When game-medium stage-raising processing 900 is started, the upper-limit release stage at that point is stored in the game control unit 44 as the initial value of the tentative upper-limit release stage.

In the case where only two upper-limit release stages are set for the game medium, it is possible to execute the determination processing (S1002) on the basis of the stage-raising condition set for the upper-limit release stage of the game medium at that point, without using the tentative upper-limit release stage.

In this embodiment, it is assumed that a condition that the same game medium as the target game medium is selected is set for the upper-limit release stages 0 to 2 of the target game medium, and a raising condition that a game medium not selected by the player but decided in advance is possessed by the player is set for the upper-limit release stages 3 and 4 thereof. Therefore, a player's selection input is accepted at the times of the tentative upper-limit release stages 0 to 2.

In the case where it is determined that the stage-raising condition is not satisfied in the raising-condition determination processing (S1002), a pop-up screen for presenting the raising condition is displayed (S1012), and, when a player's confirmation response input is performed, the consumption-game-medium selection-input response processing (S908) ends.

In the case where it is determined that the stage-raising condition is satisfied, it is determined whether the stage-raising condition set for the next stage is different from the stage-raising condition set for the stage of the target game medium (S1004). This can be determined depending on whether the stage-raising condition used in the determination processing in S1002 and the stage-raising condition set for the next upper-limit release stage are different. In this embodiment, it is determined that the stage-raising condition set for the next stage is a different stage-raising condition in the case where the next stage is the upper-limit release stage 3, and is not a different stage-raising condition in the other cases.

Furthermore, it is also possible that a flag is set in advance for the stage for which a different stage-raising condition has been set compared with the previous stage, and, in the case where the flag has been set, it is determined that the stage-raising condition set for that stage is different from the stage-raising condition set for the previous stage. For example, since the second stage-raising condition, which is different from stage-raising condition set for the upper-limit release stage 2, is set, as stage-raising condition, for the upper-limit release stage 3, the flag can be set to the upper-limit release stage 3.

In the case where extraction processing is performed such that game media to be displayed on a screen, on which a consumption game medium is selected by the player, are all the same as the target game medium, or in the case where game media that do not satisfy the raising condition are unable to be selected, the first stage-raising condition is always satisfied when the player selects a consumption game medium. Therefore, in such cases, it can be determined that the first stage-raising condition is satisfied, by accepting a consumption-game-medium selection input. On the other hand, in the case where consumption game media are a predetermined number of specific game media, it is determined whether selected game media satisfy the condition.

In the case where the determination result is affirmative in S1004, game-screen information is updated in order to display the transition-instruction accepting unit, which is used for making the transition to a screen for presenting the second stage-raising condition (S1006). In the case where the determination result is negative in S1004, the update (S1006) of the game-screen information for displaying the transition-instruction accepting unit is not performed.

Next, the tentative upper-limit release stage stored in the game control unit 44 is raised and is updated (S1008). Furthermore, the selected consumption game medium is deleted from the player's possessed-game-medium list and is stored in the tentatively consumed game-medium list in association with the raised stage. Thereafter, the server 20 sends the updated game-screen information to the player terminal 10, the player terminal 10 updates the game-screen display on the basis of the updated game-screen information (S1010), and the consumption-game-medium selection response processing (S908) ends.

For example, in the game screen 61 shown in FIG. 6, the tentative upper-limit release-stage display 65 of the target game medium becomes 3, and, since the second stage-raising condition set for the upper-limit release stage 3 is different from the first stage raising set for the upper-limit release stage 2, the transition-instruction accepting unit 67 is displayed.

The consumption-game-medium selection response processing is repeatedly executed every time a consumption game medium is selected, until it is determined that the stage-raising condition set for the next stage is the second stage-raising condition. When it is determined that the stage-raising condition set for the next stage is the second stage-raising condition, it is also possible not to accept a further selection of a consumption game medium or it is also possible to execute the consumption-game-medium selection response processing with respect to a newly selected game medium instead of the already selected game medium. Furthermore, it is also possible to include a function for clearing the selection of the already selected consumption game medium. In this case, the tentative upper-limit release stage is lowered by one, the corresponding game medium is moved from the tentatively consumed game-medium list to the possessed-game-medium list, and the game screen is updated.

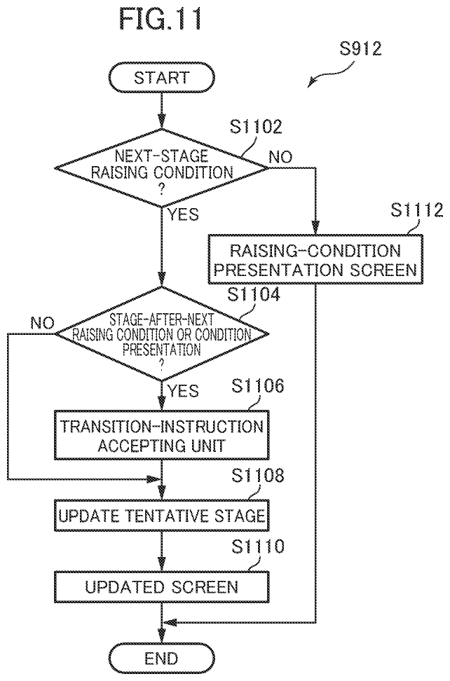

Next, in the case where the player input is not a consumption-game-medium selection input in S906 of FIG. 9, it is determined whether the player input is a transition instruction input (S910), and, in the case where the determination result is affirmative, transition-instruction response processing (S912) is executed. FIG. 11 shows one example of specific processing of the transition-instruction response processing.

It is determined whether the stage-raising condition set for the next stage is satisfied (S1102). In the case where the determination result is negative, a screen for presenting the stage-raising condition is displayed on the player terminal 10 (S1112), and the transition-instruction response processing (S912) ends. In this embodiment, an item that is required to be possessed by the player in order to satisfy the stage-raising condition set for the next stage and a confirmation button are displayed in a pop-up display, and, when a player input to the confirmation button is accepted, the pop-up display is finished, and the original game screen is displayed.

In the case where the determination result is affirmative in S1102, it is determined whether either of the following determinations is affirmative: the determination of whether the stage-raising condition set for the stage next to the next stage is different from the stage-raising condition set for the next stage; and the determination of whether presentation of the condition set for the stage next to the next stage is required (S1104).

Specific information processing for determining whether the stage-raising condition set for the stage next to the next stage is different can be realized by the same method used in S1004. In this embodiment, since a third stage-raising condition is not set, determination of whether the stage-raising condition set for the stage next to the next stage is different can be omitted in S1104. Whether presentation of the condition set for the stage next to the next stage is required can be determined, for example, when each stage for which presentation of the condition is required is stored, on the basis of whether the stage next to the next stage is a stage stored as a stage for which presentation of the condition is required. In this embodiment, the upper-limit release stage 5 is stored as the stage for which presentation of the condition is required.

In the case where the determination result is affirmative, update of game-screen information is performed in order to display the transition-instruction accepting unit (S1106). In the case where the determination result is negative, update processing of game-screen information for displaying the transition-instruction accepting unit is not performed. Thereafter, the tentative upper-limit release stage is raised by one, the consumption game medium that is required to satisfy the stage-raising condition and that is possessed by the player is deleted from the possessed-game-medium list and is stored in the tentatively consumed game-medium list in association with the raised stage. Then, the game-screen information is also updated (S1108), and the game screen is displayed at the player terminal 10 on the basis of the updated game-screen information (S1110). The game screen 70 in FIG. 7 is one example of a game screen in which the transition-instruction accepting unit 74, which is used for displaying the condition set for the stage further next to the next stage, is displayed.

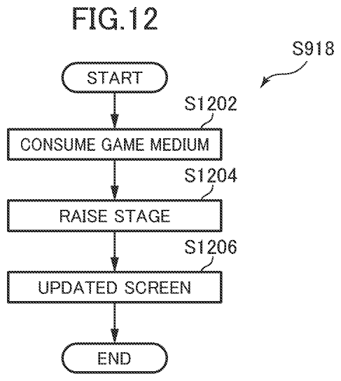

Returning to FIG. 9, in the case where it is determined that the player input is a stage-raising instruction (S918), the stage-raising-instruction response processing is executed (S920). FIG. 12 shows one example of specific information processing of the stage-raising-instruction response processing. When an input to the stage-raising-instruction accepting unit is accepted, a confirmation screen that presents a consumption game medium (or media) stored in the tentatively consumed game-medium list is displayed. When the player performs a confirmation input, the identifier of a consumption game medium that is required for raising the stage to the tentative raising stage and that is stored in the game control unit 44 in association with the player identifier is deleted from the tentatively consumed game-medium list, whereby this consumption game medium is consumed (S1202). Then, the parameter indicating the stage of the target game medium stored in the game control unit 44 is raised up to the tentative upper-limit release stage (S1204). When a player input for returning is executed in the confirmation screen, the screen may be returned to the screen displayed before the stage-raising instruction is accepted.

The raising response processing in the all-at-once mode in this embodiment is executed all at once up to a desired stage (tentative upper-limit release stage) by consuming consumption game media required for raising the stage to a raised stage desired by the player. A consumption game medium selected by a player input in order to satisfy the first stage-raising condition and a consumption game medium required to satisfy the second stage-raising condition are all consumed, whereby the stage of the target game medium is raised to the desired raised stage.

For example, in this embodiment, in the case where the stage-raising processing is executed, with respect to a target game medium in an upper-limit release stage 0, up to a tentative upper-limit release stage 4, three game media that are the same as the target game medium and that are selected by the player for raising the stage to the upper-limit release stages 1 to 3 and a game medium that is required to raise the target game medium to the upper-limit release stage 4 are all deleted from the possessed items of the player, and the upper-limit release stage of the target game medium is updated to 4.

The game control unit 44 generates screen information indicating that stage raising for the target game medium has been executed, causes a game screen to be displayed on the display unit 32 of the player terminal 10 (S1206), and ends the stage-raising-instruction response processing.

Furthermore, in the case where, although the player desires further upper-limit releasing and transitions the game screen, the player has a second thought that upper-limit releasing to that extent is not desired after viewing the presentation of an upper-limit release condition, the player touches the return button 76 (S914), whereby the tentative upper-limit release stage is returned to the previous tentative upper-limit release stage, and the game screen is transitioned to the previous game screen (S916). The game control unit 44 stores the previous tentative upper-limit release stage and the previous game screen, thereby making it possible to return to the stored states in response to a return input. The consumption game medium associated with the returning-target stage is deleted from the tentatively consumed game-medium list and is returned to the player's possessed-game-medium list.

In FIG. 9, in the case where the player input is none of a consumption-game-medium selection input, a transition instruction, a return instruction, and a stage-raising instruction, the player input is handled as an end input for ending the stage-raising processing for the target game medium. In this case, processing for ending the stage-raising processing for the target game medium is executed (S922). For example, it is possible to display a selection screen for selecting a new target game medium on the player terminal 10 and to display a main menu image for accepting an input for playing a game or another player input.

In this embodiment, although the stage-raising ending processing is also executed after the raising-instruction response processing (S920) is executed when the player input is a stage-raising instruction, it is also possible that the flow is returned to S904 in order to accept a further stage-raising input for the target game medium.

In a game in which any of a plurality of stage-raising conditions different from each other is set for any of the stages of a game medium, since it is necessary to accept a stage-raising instruction while making the player recognize the different stage-raising conditions, it is usual to perform stage-raising processing for each stage. When multiple stages are to be raised, if inputs are performed while transitioning the game screens many times for selection of a target game medium, selection of a consumption game medium or presentation of a consumption game medium, and a stage-raising instruction, the procedure is very complicated, and the amount of data transmission for displaying the game screens becomes large in the server-client system.

By using this embodiment, even in a game in which any of a plurality of stage-raising conditions different from each other is set for any of the stages of a game medium, in the case of a stage where the stage-raising condition set for the next stage is different, the transition-instruction accepting unit, which is used for making the transition to a screen for stage raising to the next stage, is displayed to notify the player that the stage-raising condition will be changed, thereby making it possible to provide a user interface capable of executing multiple-stage raising all at once. In the case where the same stage-raising condition is set for a plurality of stages, the player is allowed to perform a game-medium selection input in one game screen, and a transition instruction for presenting a new stage-raising condition is displayed at the stage where the stage-raising condition will be changed, thereby making it possible to suppress the number of game-screen transitions, to reduce the amount of data transmitted from the server due to the screen transitions, and to simplify the input operation of the player.

Furthermore, it is possible to execute all-at-once stage raising to a stage desired by the player, instead of fixed processing for raising the stage up to the maximum stage, thus allowing a further increase in player operability. If the stage-raising condition for the next stage is displayed on the screen, the player can decide up to which stage raising is to be executed, after confirming this condition. For example, it is possible that a player who wishes to perform upper-limit releasing for a target game medium other than the selected target game medium executes stage raising systematically while confirming a game medium to be consumed.

### [Modification]

A description will be given of a modification in which, unlike the above-described embodiment, the first stage-raising condition is a condition that a game medium that is not selected by the player but is determined in advance and possessed by the player is consumed, and the second stage-raising condition is a condition that a game medium that is selected by the player and is the same as the target game medium is consumed. It is assumed that the first stage-raising condition is set for the upper-limit release stages 0 to 2, and the second stage-raising condition is set for the upper-limit release stages 3 and 4.

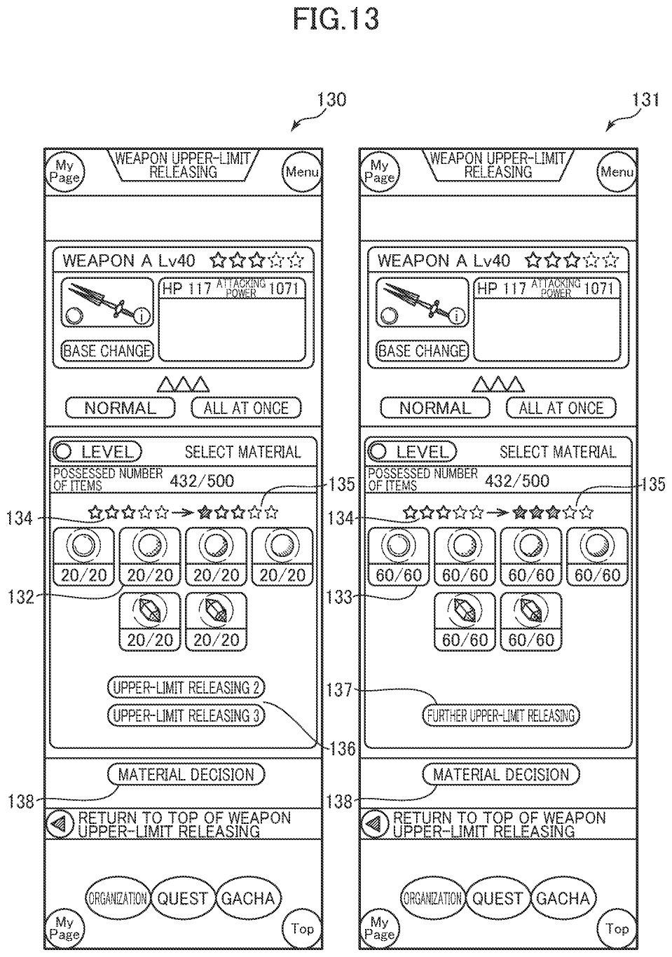

In the modification, first, it is determined whether the stage-raising condition for upper-limit releasing of only one stage is satisfied. In the case where it is determined that the stage-raising condition is not satisfied, a pop-up screen for presenting the stage-raising condition is displayed, and, when a player's confirmation response is accepted, the screen is returned to the original screen. In the case where it is determined that the stage-raising condition is satisfied, if the upper-limit release stage of the target game medium is 0, as shown in FIG. 13, the tentative upper-limit release stage is set to 1, and game media 132 required for stage raising are presented.

Furthermore, player-input buttons 136 for performing upper-limit releasing up to the upper-limit release stage 2, for which the first stage-raising condition has been set, or the upper-limit release stage 3 are displayed. It is possible to select the stage serving as a raising target, from among the stages for which the first stage-raising condition has been set. When the player touches either one of the player-input buttons, consumption game media 133 required to perform stage raising to the selected upper-limit release stage are displayed on the game screen 131.

Furthermore, in the case where the stage-raising condition set for the stage next to the tentative upper-limit release stage is the second stage-raising condition, in this embodiment, if the tentative upper-limit release stage is 3, a transition-instruction accepting unit 137 for instructing game-screen transition for raising the stage to the next upper-limit release stage 4 is displayed. When a player input is performed with respect to the transition-instruction accepting unit 137, a screen for selecting the same consumption game medium as the target game medium, like the game screen 60 of FIG. 6, is displayed.

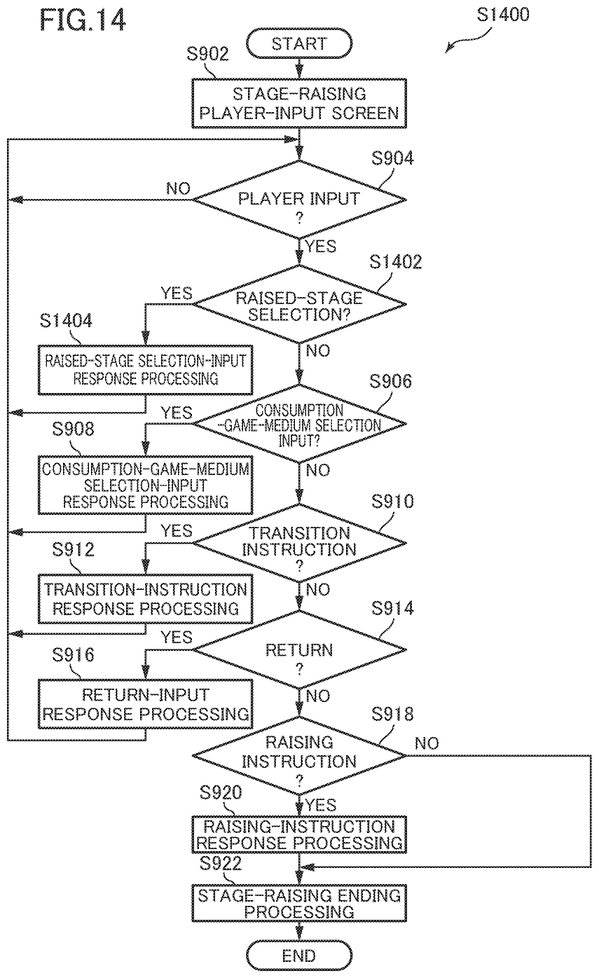

FIG. 14 shows one example of a flowchart 1400 of information processing for realizing the modification. For simplification of description, differences from the flowchart shown in FIG. 9 will be mainly described. Identical reference numbers are assigned to the same processing procedures as those in FIG. 9. When a target game medium is selected by the player, and it is determined that the stage-raising condition for performing upper-limit releasing of one stage is satisfied, a stage-raising player-input screen 130 is displayed on the player terminal 10 (S902). Then, if it is determined that a player input is a raised-stage selection (S1402), a raised-stage selection-input response processing (S1404) is executed.

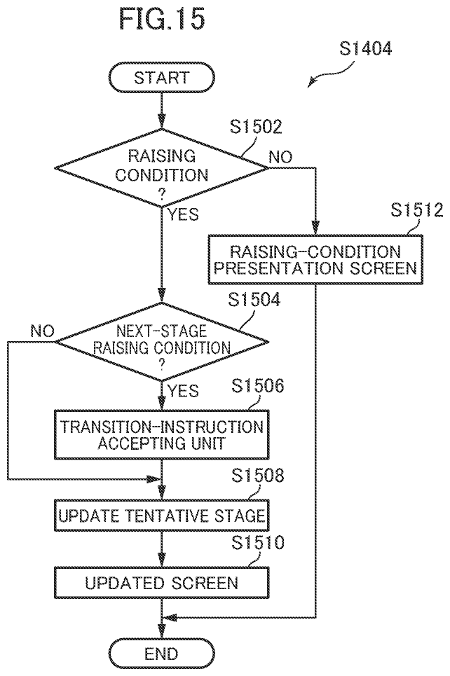

FIG. 15 shows one example of a flowchart of the upper-limit-stage selection-input response processing (S1404). This processing is similar to the consumption-game-medium selection-input response processing (S908). Specifically, it is determined whether the player possesses a game medium that is required to execute stage raising up to the upper-limit release stage selected by the player (S1502). In the case where the determination result is negative, a pop-up screen for presenting a required game medium (or media) is displayed (S1512). When a player's confirmation input is accepted, the screen is returned to the stage-raising player-input screen 130.

In the case where the determination result is affirmative, it is determined whether the second stage-raising condition is set for the next stage after stage raising (S1504). In the case where the determination result is affirmative, the game-screen information is updated so as to display the transition-instruction accepting unit 137 (S1506). In the case where the determination result is negative, the game-screen information is not updated. The tentative upper-limit release stage of the target game medium is raised on the basis of a player's selection input, the consumption game medium required to satisfy the stage-raising condition and possessed by the player is deleted from the possessed-game-medium list and is stored in the tentatively consumed game-medium list in association with the raised stage, and the game-screen information is updated (S1508). Then, the updated game screen is displayed on the player terminal 10 (S1510). In the case where the tentative upper-limit release stage is 2, the input accepting unit 136 for raising the upper-limit release stage to 3 is displayed on the updated game screen.

The other processing procedures, such as the consumption-game-medium selection-input response processing (S908), the transition-instruction response processing (S912), the return-input response processing (S916), and the raising-instruction response processing (S920), are same as those shown in FIGS. 9 to 12. In this modification, since a third stage-raising condition is not set while the second stage-raising condition is set for the upper-limit release stages 3 and 4, next-stage raising-condition determination (S1008) and transition-instruction accepting-unit information generation processing (S1010) are unnecessary in the consumption-game-medium selection-input response processing (S908). If the third stage-raising condition is set, stage-raising processing can be realized by implementing those processing procedures.

By using this modification, in the stages for which the first stage-raising condition has been set, it is possible to select the stage up to which raising is performed, while confirming a game medium (or media) to be consumed regardless of the player's selection, to allow a player's selection input of a consumption game medium for satisfying the second stage-raising condition in a screen displayed in response to an input to the transition-instruction accepting unit, and to realize stage-raising processing all at once up to the desired stage.

In the above-described embodiment, although a description has been given of an example case in which a web application is used in the player terminal 10 to make the user play a game, it is also possible that a native application is stored in the storage device 14 in the player terminal 10, and information processing for proceeding with a game is executed by executing the native application. The native application includes a game program for executing the game and various kinds of data to be referred to when the game program is executed. The native application is activated in accordance with an operation of the user with respect to the player terminal 10, and is executed on an operating system (OS) implemented in advance in the player terminal 10. In this case, in the above-described embodiment, at least part of the function of the server 20 can be included in the player terminal 10. Furthermore, in another embodiment, the execution may be possible only with one player terminal 10 without communication with the server 20.

The processing or operation described above can be modified freely as long as no inconsistency arises in the processing or operation, such as an inconsistency that a certain step utilizes data that may not yet be available in that step. Furthermore, the examples described above are examples for explaining the present invention, and the present invention is not limited to those examples. The present invention can be embodied in various forms as long as there is no departure from the gist thereof.

### REFERENCE SIGNS LIST

1 game system
2 network
10 player terminal
11 processor
12 display device
13 input device
14 storage device
15 communication device
16 bus
20 server
21 processor
22 display device
23 input device
24 storage device
25 communication device
26 bus
31 input unit
32 display unit
33 communication unit
34 game control unit
41 input unit
42 display unit
43 communication unit
44 game control unit
45 stage-raising-condition determination unit
46 stage-transition determination unit
48 game screen
49 image

1. A non-transitory computer readable medium storing a program that is used in a game capable of raising a stage of a game medium stored in association with player identification information of a player, any of a plurality of stage-raising conditions different from each other being set for any stage,
the program being characterized by causing a computer to execute:
a step of determining, upon acceptance of a player input for selecting a target game medium from among a game medium (or media) stored in association with the player identification information, the stage of the target game medium being to be raised, whether a first stage-raising condition set for the stage of the target game medium is satisfied;
a step of determining whether a stage-raising condition set for the next stage thereof is a second stage-raising condition, in the case where it is determined that the first stage-raising condition is satisfied; and
a step of displaying a transition-instruction accepting unit for making a transition to a screen for presenting the second stage-raising condition, in the case where it is determined that the stage-raising condition set for the next stage is the second stage-raising condition,
wherein one of the first stage-raising condition and the second stage-raising condition includes consuming a game medium selected by the player.

2. The non-transitory computer readable medium according to claim 1, characterized in that the step of determining whether the first stage-raising condition is satisfied further comprises a step of determining that the first stage-raising condition is satisfied upon acceptance of a player input for selecting a predetermined consumption game medium.

3. The non-transitory computer readable medium according to claim 2, characterized by causing the computer to further execute:
a step of displaying a stage-raising-instruction accepting unit with respect to the stage for which the second stage-raising condition has been set, upon acceptance of a player input to the transition-instruction accepting unit, which is displayed when it is determined that the first stage-raising condition is satisfied; and
a step of consuming the consumption game medium selected for satisfying the first stage-raising condition and a consumption game medium for satisfying the second stage-raising condition, upon acceptance of an input to the stage-raising-instruction accepting unit.

4. The non-transitory computer readable medium according to claim 2, characterized in that:
the step of determining whether the first stage-raising condition is satisfied further comprises a step of displaying a stage to which raising is possible if the first stage-raising condition is satisfied, upon acceptance of a player input for selecting a predetermined consumption game medium; and
the step of displaying the transition-instruction accepting unit, which is used for making a transition to the screen for presenting the second stage-raising condition, further comprises a step of displaying a stage to which raising is possible if the second stage-raising condition is satisfied, in the case where it is determined that the second stage-raising condition is satisfied.

5. The non-transitory computer readable medium according to claim 1, characterized in that the second stage-raising condition is determined on the basis of whether a game medium, which is decided on the basis of a raising-target stage for which the second stage-raising condition has been set, satisfies a predetermined condition.

6. The non-transitory computer readable medium according to claim 1, characterized by causing the computer to further execute a step of displaying a game medium required to satisfy the second stage-raising condition, upon acceptance of a player input with respect to the transition-instruction accepting unit.

7. The non-transitory computer readable medium according to claim 1,
characterized in that the step of determining whether the first stage-raising condition is satisfied further comprises
a step of accepting a player input for selecting a raised stage for which the first stage-raising condition has been set, and
a step of determining that the first stage-raising condition is satisfied in the case where a game medium decided on the basis of the selected stage satisfies a predetermined condition; and
characterized by causing the computer to further execute, upon acceptance of a player input with respect to the displayed transition-instruction accepting unit, which is used for making a transition to the screen for presenting the second stage-raising condition,
a step of accepting a player input for selecting a consumption game medium, and
a step of determining that the second stage-raising condition is satisfied in the case where the selected consumption game medium satisfies a predetermined condition.

8. The non-transitory computer readable medium according to claim 6, characterized in that:
the step of determining whether the first stage-raising condition is satisfied further comprises a step of displaying a stage to which raising is possible if the first stage-raising condition is satisfied; and
the step of displaying the transition-instruction accepting unit, which is used for making a transition to the screen for presenting the second stage-raising condition, further comprises a step of displaying a stage to which raising is possible if the second stage-raising condition is satisfied.

9. The non-transitory computer readable medium according to claim 1, characterized in that the target game medium and the consumption game medium that is selected by the player input are assigned to the player on the basis of a predetermined lottery process.

10. The non-transitory computer readable medium according to claim 1, characterized in that:
the first stage-raising condition is set for a plurality of stages; and
the step of determining whether the first stage-raising condition is satisfied is executed with respect to each of the stages for which the first stage-raising condition has been set, until it is determined that the stage-raising condition set for the next stage is the second stage-raising condition.

11. An electronic device that is used in a game capable of raising a stage of a game medium stored in association with player identification information of a player, any of a plurality of stage-raising conditions different from each other being set for any stage,
the electronic device being characterized by:
determining, upon acceptance of a player input for selecting a target game medium from among a game medium (or media) stored in association with the player identification information, the stage of the target game medium being to be raised, whether a first stage-raising condition set for the stage of the target game medium is satisfied;
determining whether a stage-raising condition set for the next stage thereof is a second stage-raising condition, in the case where it is determined that the first stage-raising condition is satisfied; and
displaying a transition-instruction accepting unit for making a transition to a screen for presenting the second stage-raising condition, in the case where it is determined that the stage-raising condition set for the next stage is the second stage-raising condition,
wherein one of the first stage-raising condition and the second stage-raising condition includes consuming a game medium selected by the player.

12. A method that is used in a game capable of raising a stage of a game medium stored in association with player identification information of a player, any of a plurality of stage-raising conditions different from each other being set for any stage,
the method being characterized by causing a computer to execute:
a step of determining, upon acceptance of a player input for selecting a target game medium from among a game medium (or media) stored in association with the player identification information, the stage of the target game medium being to be raised, whether a first stage-raising condition set for the stage of the target game medium is satisfied;
a step of determining whether a stage-raising condition set for the next stage thereof is a second stage-raising condition, in the case where it is determined that the first stage-raising condition is satisfied; and
a step of displaying a transition-instruction accepting unit for making a transition to a screen for presenting the second stage-raising condition, in the case where it is determined that the stage-raising condition set for the next stage is the second stage-raising condition,
wherein one of the first stage-raising condition and the second stage-raising condition includes consuming a game medium selected by the player.
